(19) United States
(12) Patent Application Publication
(10) Pub. No.: US 2005/0236788 A1
(43) Pub. Date: Oct. 27, 2005

(54) Combination tool box and dolly

(76) Inventor: Douglas E. Kellogg, Canal Winchester, OH (US)

Correspondence Address: KREMBLAS, FOSTER, PHILLIPS & POLLICK, 7632 SLATE RIDGE BOULEVARD, REYNOLDSBURG, OH, 43068, US

(21) Appl. No.: 10/828,801

(22) Filed: Apr. 21, 2004

(51) Int. Cl. B62B 1/00

(52) U.S. Cl. 280/79.2

(57) ABSTRACT

A combination portable dolly and tool box which includes a generally rectangular main body forming a storage area confined between front and rear side walls, opposing end walls, a bottom wall carried by a pair of wheels and a top wall forming both a lid and a load support surface. The top wall is configured to provide an inclined load surface which cooperated with a removably mounted vertically extending frame to allow relatively large construction panels, such as dry wall of the like to be transported in a vertically stacked on-edge relationship in a manner commonly associated with the widely known “dry wall dolly”. The vertical frame may be removed and may be stored in a releasably fixed position within the storage area of the main body which also accommodates for the storage of tools and accessory items commonly used. Further, a handle is provided on one end of the main body to allow the main body to be raised on one end for rolling transport on an opposing set of wheels as a whole for travel from one site to another.

### (e) BACKGROUND OF THE INVENTION

1. Field of the Invention

This invention relates generally to portable carts or dollies for transporting loads and particularly to an easily portable dolly and tool box combination useful in one configuration to transport relatively large panels of building materials which also includes a secure interior compartment for storing tools and related equipment useful for construction purposes from one site to another.

2. Description of the Related Art

In the construction trade generally, and particularly in many commercial applications wherein large panels or prefabricated wall structures are employed, a specialized dolly is often used to transport wall panels or the like. Such wall panels are typically used in commercial applications to erect room divisions or to set off merchandizing areas for the display of goods or to remodel interior spaces. Such specialized dollies typically include a bed surface inclined to the horizontal which cooperates with a vertical frame to allow transporting relatively large panels horizontally aligned on their narrow edges. Such panels may consist of wood, synthetic material, or drywall, for example. These panels require transport from a receiving site to and throughout the area in which the panels are erected. However, such specialized “dry wall dollies”, as often referred to in the trade, are considered less than satisfactory to transfer other types of load materials or such panels stacked vertically upon one another because the inclined surface of the bed and the vertical frame reduce or interfere with the convenience and usable surface area of the load receiving bed.

Typical flat bed dollies, on the other hand, are not as convenient to receive and transport a significant plurality of such large panels in a single load. Therefore, to provide the most efficient and convenient mode of transportation for such materials, separate types of one or more of such carts or dollies must be made available at the work site.

In particular, with respect to remodeling a room or the installation of wall dividers associated with constructing a merchandising display area within a room or other large area, often it is inconvenient for the installation crew to obtain either of the above types of dollies for a particular installation. This is particularly true when an installation crew representing a small number of people must travel from a relatively distant location to the work site via auto or common carrier. In such a case they must arrange to rent or otherwise obtain such dollies from local sources near the job site.

In addition to providing a dolly of the type described, the installation crew must also bring their tools and other related accessory items necessary or helpful to accomplish their task. If such dollies, as described above, are not available, transporting such panels manually is more difficult, time-consuming and labor intensive which tends to raise costs.

Prior to the present invention, those skilled in this art have not found a fully satisfactory solution to eliminate the inconvenience and difficulties described above.

### (f) BRIEF SUMMARY OF THE INVENTION

The present invention relates to an apparatus forming a combined dolly and tool box which is capable of quickly converting into multiple configurations to provide an apparatus having the ability to accommodate the transport of multiple building panels or other materials in either an on edge vertical array or in a horizontally stacked disposition on the bed of the dolly. Additionally, the apparatus of the present invention functions as a portable tool box providing convenient storage and accessibility for tools and accessory items which is easy to transport for travel from one work site to the other in a relatively compact and secure configuration.

As one aspect of the present invention, the combination dolly and tool box configuration includes a main body portion forming a primary tool storage compartment including side walls, a bottom wall provided with wheel means, and a top wall hingedly connected to one of the side walls to provide a dual function as a closeable lid and a load bed for carrying construction materials for transport throughout a given work area.

In a more preferred embodiment, the top wall forming the lid provides an inclined load supporting surface when closed which cooperates with a removably mounted vertically extending frame to form a “dry wall” cart configuration. When the vertical frame is dismounted, a vertically extending lip from the low end of the load supporting bed surface permits transport of panel wall section units in an alternative horizontally stacked arrangement or conveniently accommodate other forms of material loads in a manner functional equivalent to a “flat bed” conventional dolly.

It is another aspect of the present invention to sectionalize the compartment formed within the main body portion so that tools and other accessories may be stored in a convenient and compact manner for travel as well as easy access at the work site.

It is a further aspect of a preferred embodiment of the present invention to form the top wall or lid with downwardly extending side walls which mate with the side walls forming the main body portion to provide a further independent storage space for the removable frame members and other tool accessory items, if desired. This provides a particularly convenient manner to obtain a compact configuration for transporting the combined dolly and tool box from one work site to another with the required tools and accessories for construction of set-off commercial display areas or room remodeling applications.

In a further preferred embodiment, one end of the main body portion may include a pair of brackets which slideably receive a base plate conveniently stored within the main body and the opposing end is provided with a handle. In this configuration, the main body portion may be converted into a two-wheeled hand truck for transporting boxes and the like around the workplace. Without installing the base plate, the handle conveniently permits the main body to be lifted at one end for easy rolling transport in the closed position with all its contents to and from a work site in a tilted disposition supported on one pair of wheels.

### (g) BRIEF DESCRIPTION OF THE SEVERAL VIEWS OF THE DRAWINGS

FIG. 1 is a perspective view of a preferred embodiment of a portable cart and tool box combination constructed in accordance with the present invention;

FIG. 2 is a perspective view of the cart and tool box shown in FIG. 1 illustrated with the top wall shown in an open position to provide access to the interior compartment for storing tools and accessory items;

FIG. 3 is a perspective view similar to FIG. 2 illustrating a preferred embodiment with examples of some tool accessories capable of being organized and stored within the interior compartment;

FIG. 4 is a perspective view of the embodiment shown in FIG. 1 illustrating in exploded relationship removably mounted frame members forming a part of the preferred embodiment useful to convert the apparatus into a form most useful to transport wall panels and the like on their edges in a vertical arranged array;

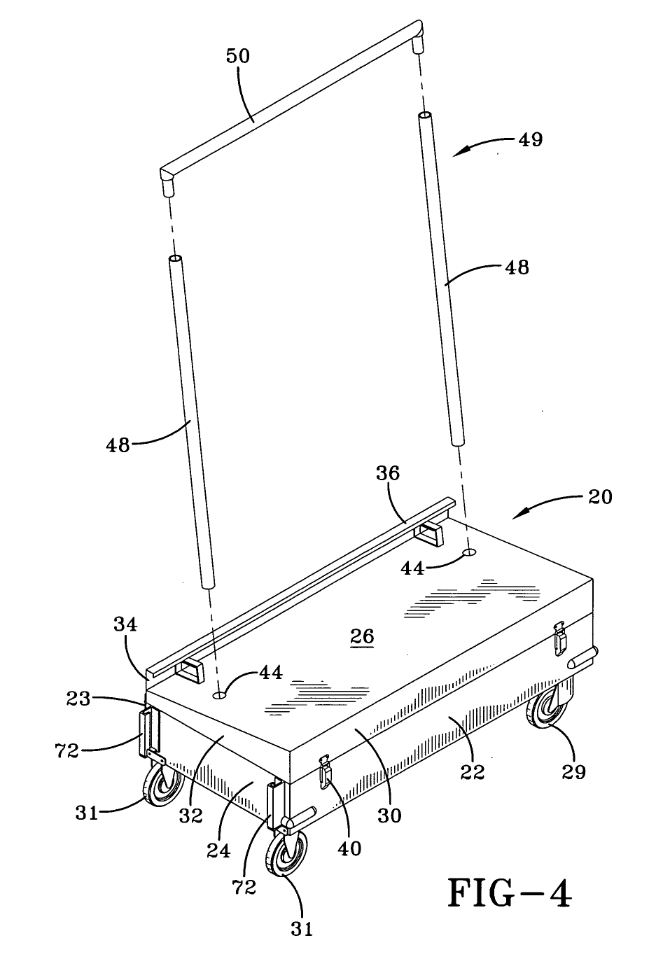

FIG. 5 is a perspective view similar to the view in FIG. 4, illustrating the preferred embodiment with the frame members in a fully installed operable position;

FIG. 6 is a perspective view of the embodiment shown in the preceding FIGS. illustrating another configuration wherein the apparatus is converted into a two-wheeled hand truck; and

FIG. 7 is a perspective view of the embodiment shown in FIG. 6 illustrating the opposing side of embodiment shown the hand truck configuration.

In describing the preferred embodiment of the invention which is illustrated in the drawings, specific terminology will be resorted to for the sake of clarity. However, it is not intended that the invention be limited to the specific term so selected and it is to be understood that each specific term includes all technical equivalents which operate in a similar manner to accomplish a similar purpose. For example, the word connected or term similar thereto are often used. They are not limited to direct connection, but include connection through other elements where such connection is recognized as being equivalent by those skilled in the art.

### (h) DETAILED DESCRIPTION OF THE INVENTION

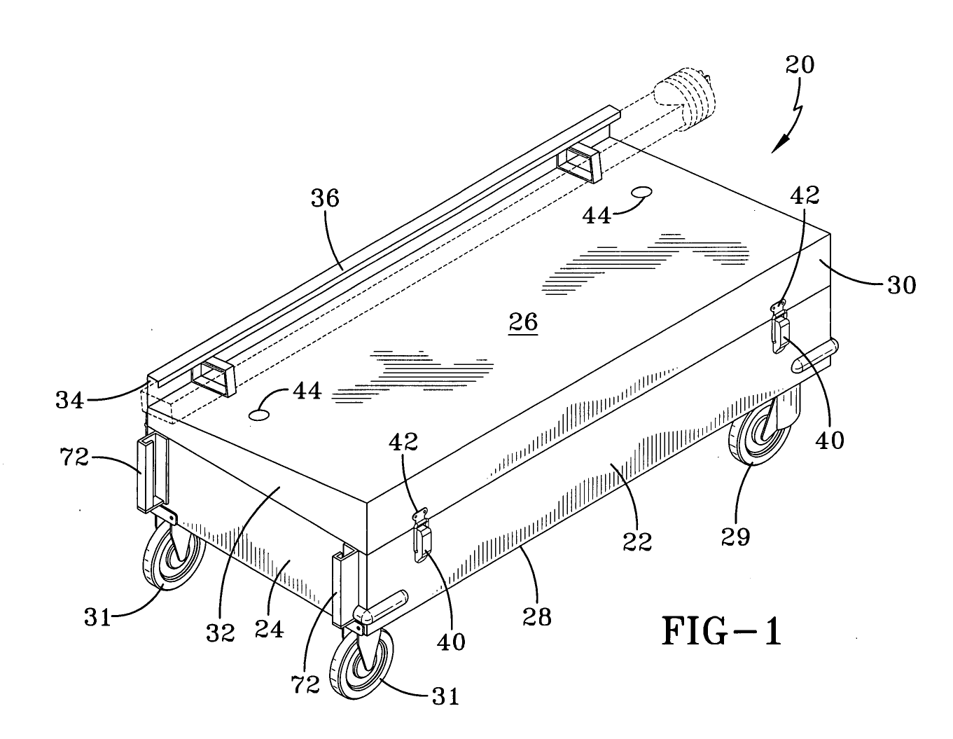

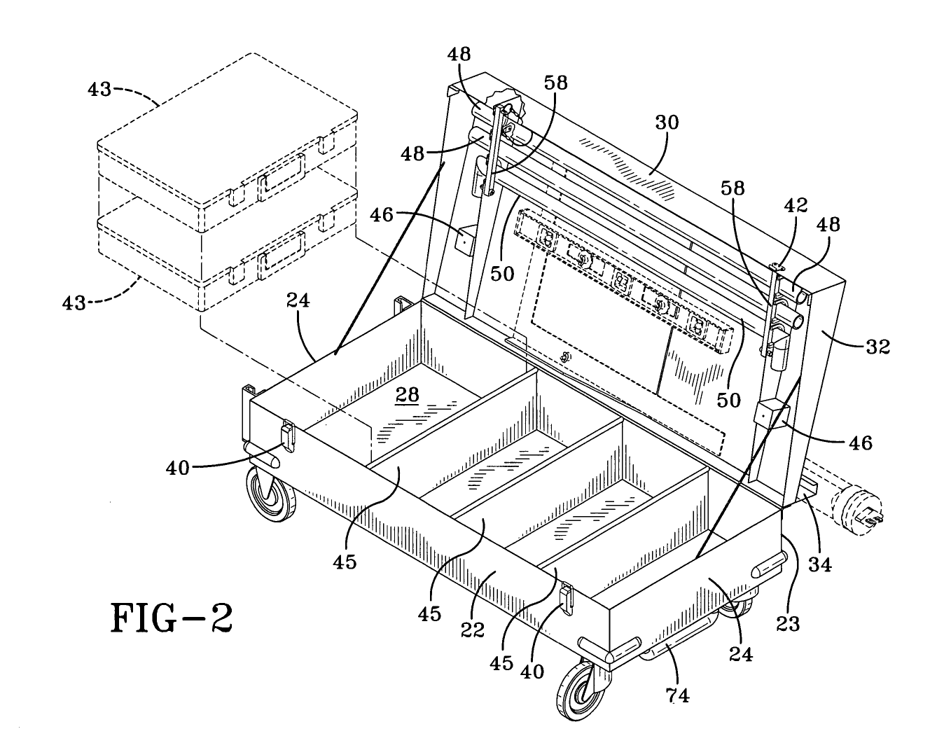

A combined dolly and portable tool box apparatus constructed in accordance with the present invention is shown in FIGS. 1 and 2 and comprises a generally rectangular-shaped main body portion, indicated generally at 20, comprising opposing front and rear side walls 22 and 23, end walls 24, a top wall 26 and a bottom wall 28 forming an enclosed compartment or primary storage space.

Bottom wall 28 includes wheel means in the form of a pair of castor wheels 29 and fixed wheels 31 conventionally mounted at or near each corner of bottom wall 28.

Top wall 26 may be preferably hingedly connected along the rear side wall 23 in any suitable conventional manner, such as at 25, between an open position, as seen in FIG. 2, and a closed portion as shown in FIG. 1.

Preferably top wall 26 comprises four downwardly depending wall portions, 30, 32 and 34 which are configured to rest upon the upper edges of side walls 22, 23 and end walls 24, to create a lid and secondary storage space within the confines of top wall 26 and depending wall portions 30, 32 and 34, independent of the primary storage compartment within the confines of side walls 22, 23, end walls 24 and bottom wall 28.

In the preferred embodiment, the upper surface of top wall 26 is configured to form an incline from one of the front side walls 22 to the rear side wall 23 which is accomplished by the configuration of downwardly depending wall portions 32 which are higher toward the front where they join depending wall portion 30 to a lower elevation where they join depending wall portion 34. Wall portion 34 includes an extended portion which rises to a height substantially equal to the height of wall portion 30 and terminates in an L-shaped flange 36 which preferably lies in substantially the same horizontal plane as the upper edge of depending wall portion 30 where it joins top wall 26.

When top wall 26 is in the closed position, as seen in FIG. 1, the broad upper surface forms an inclined load bed between depending wall portions 30 and 34.

Top wall 26 may be secured in the closed position in any conventional well-known manner, such as for example, employing a pair of conventional draw latches 40 mounted on side wall 22 mating with hook-like parts 42 mounted on downwardly depending wall portion 30.

With specific reference to FIG. 2 illustrating top wall 26 in the open position, it is preferable to provide removably mounted interior dividers, such as indicated at 45, of any suitable conventional construction to create discrete divisions of space deemed best to store tools and accessories in an orderly and secure manner.

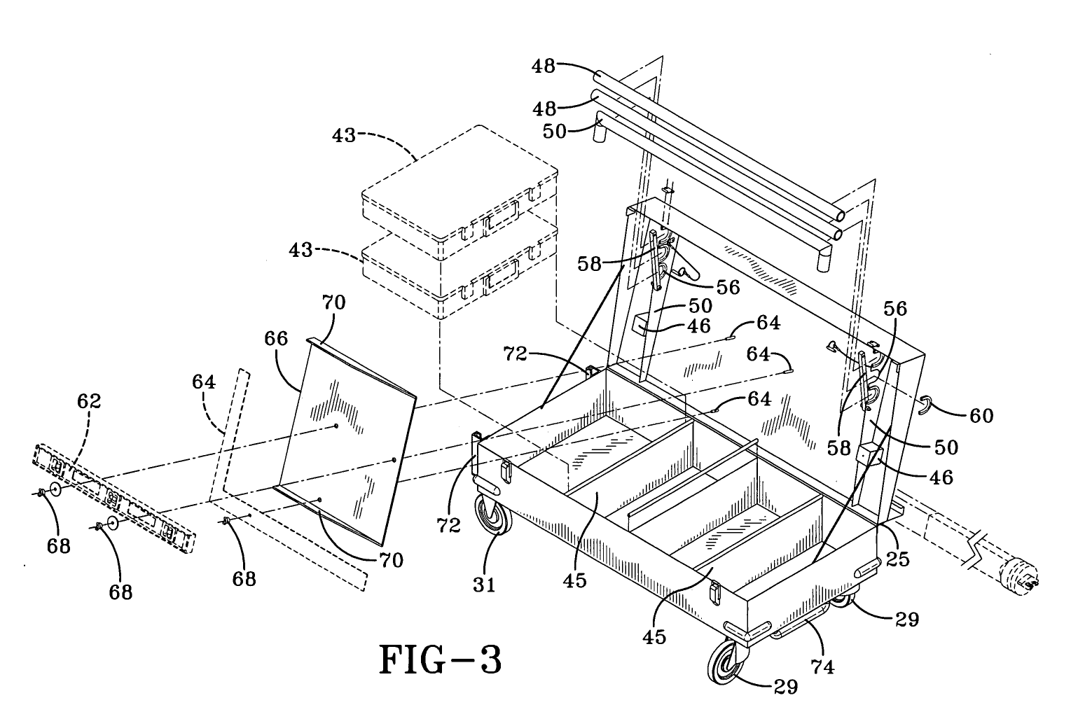

A pair of self contained tool containers 43 are shown in ghost lines in FIG. 3 and may be adapted to fit into one or more of the spaces between dividers 45 as merely an example of one convenient manner to carry smaller tools or other items in a secure and orderly manner within the primary interior storage compartment.

Referring to FIGS. 1, 2 and 3, top wall 26 is provided with a pair of spaced openings or holes 44, each of which is aligned with a holding or frame support block 46 welded or otherwise secured to the underside or interior surface of top wall 26. The holding blocks 46 are provided with an upwardly facing blind opening or hole, not shown, adapted to removably receive and retain the lower end of a respective one of a pair of legs 48 extended through a respective opening 44. Legs 48 form a part of vertically extending frame 49 which includes a horizontal cross member 50 connected between legs 48.

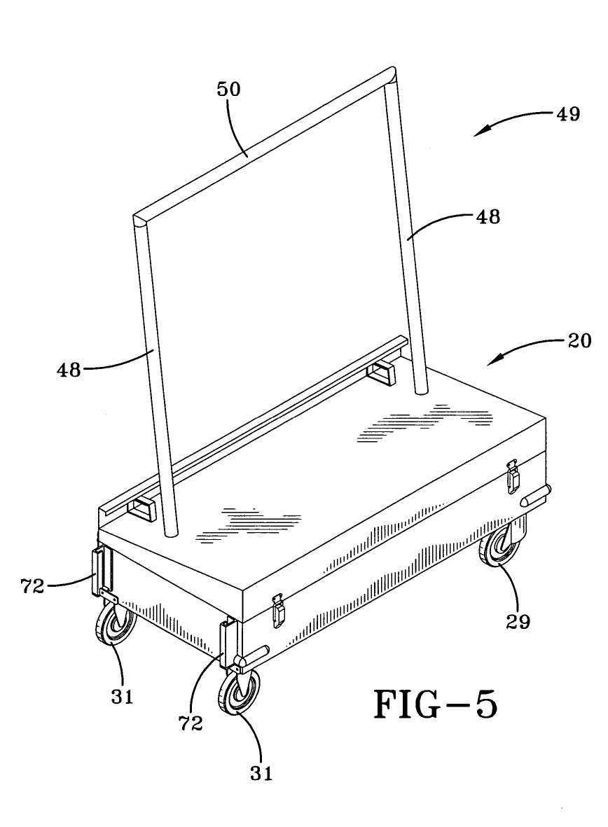

Legs 48 and cross member 50 may take the form of rigid tubes wherein cross member 50 includes L-shaped ends, each adapted to be slideably received within a top opening of one of legs 48. With the vertically extending frame assembled in the position shown in FIG. 5, the present invention assumes a conventional “dry wall dolly” form, as commonly known in the trade. In cooperation with the inclined bed formed by top wall 26, a plurality of wall panels may be loaded side by side on their edges upon top wall 26 in a slightly inclined vertical attitude generally perpendicular to the incline of top wall 26 and supported by frame 49 and one another for convenient transport from one area to another. It is desirable to provide top wall 26 with a non-slip surface in any conventional manner to more safely assure a load of panels maintain their position during transport. For example, a synthetic layer or roughed surface may be used to increase the frictional contact of the load with top surface 26.

It is pointed out that the inclined surface found in a conventional dry wall dolly is deemed important to transport such panels in a slightly inclined and vertically disposed on-edge relationship to better maintain their position enhanced by the support offered by vertical support frame 49.

On the other hand, in the event such items as wall panels or large sheeting materials must be disposed on their wide faces in a horizontal position for any reason, one merely removes legs 48 and cross member 50. Then such wall panels may be laid across top wall 26 and rest in a substantially horizontal position upon the upraised lip 36 of rear wall 34 and the front edge of top wall 26 at its joiner with depending wall portion 30.

In this latter configuration, the present invention functions substantially equivalent to a conventional dolly having a horizontal flat load bed to carry loads which would be inconvenient or unsafe to transport using a conventional “dry wall dolly”.

With reference to FIGS. 2 and 3, the secondary storage space formed between top wall 26 and the depending wall portions described herein provides a convenient carrying space for legs 48 and cross member 50 when not required and for travel between working locations. Spaced divider walls 50 may be fixed to the underside of top wall 26 and/or depending walls 30 and 34 and include a plurality of opposing recesses 56, each configured to receive one of legs 48 or member 50. A closure bar 58 pivotally connected at one end to a divider wall 54, may be provided for movement between an open position uncovering the recesses 56, and a closed position blocking the upper opening of each recess 56. Closure bar 58 may be releasably fixed in the closed position in any suitable conventional manner well-known to one or ordinary skill, such as via a tie-down cord or the like, not shown, having a free end removably fixed to a divider wall 54.

Alternatively, or in addition to if desired, each recess 56 may be fitted with a fixed semicircular, pliable insert such as 60, which may be dimensioned to receive legs 48 and cross member 50 in a close-fit frictional engagement to stabilize and releasably hold legs 48 and member 50 within a respective recess 56 in the stored position such as shown in FIG. 2.

The independent, secondary storage area formed within top wall 26 and its depending wall portions may also conveniently be employed to store other accessory items often useful in room remodeling or construction, such as a level 62 and right angle 64, for example, shown in ghost lines in FIG. 3. Such items may be attached to a plurality of threaded bolt fasteners provided in top wall 26, such as at 64, which may be extended through aligned holes provided in a tread plate 66 and the accessory items and fastened via a nut and washer assembly such as shown at 68.

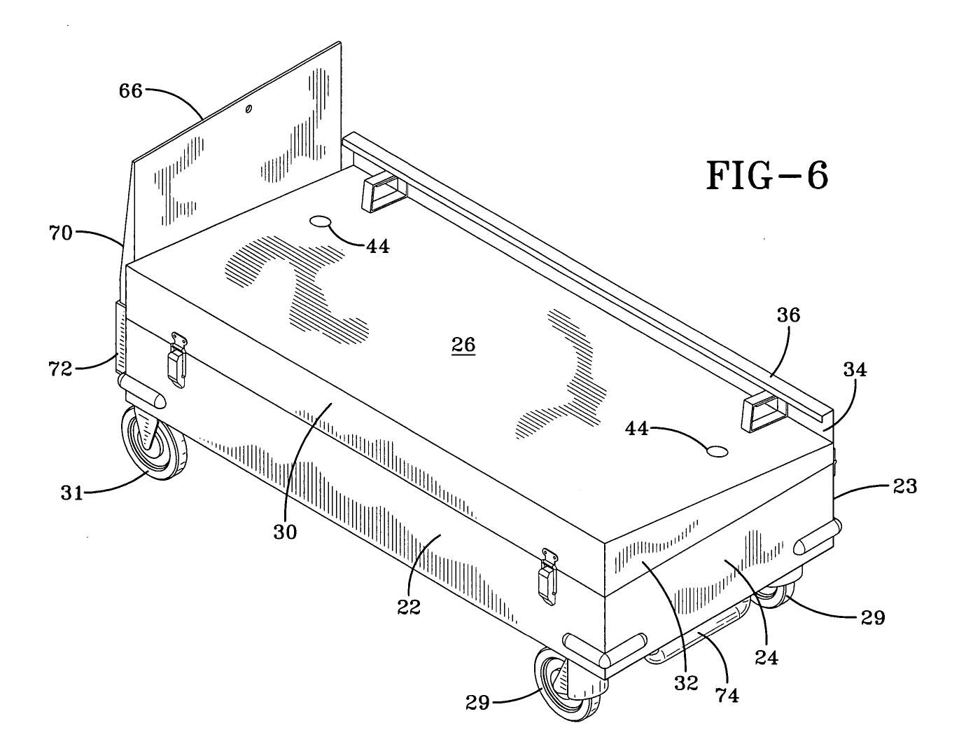

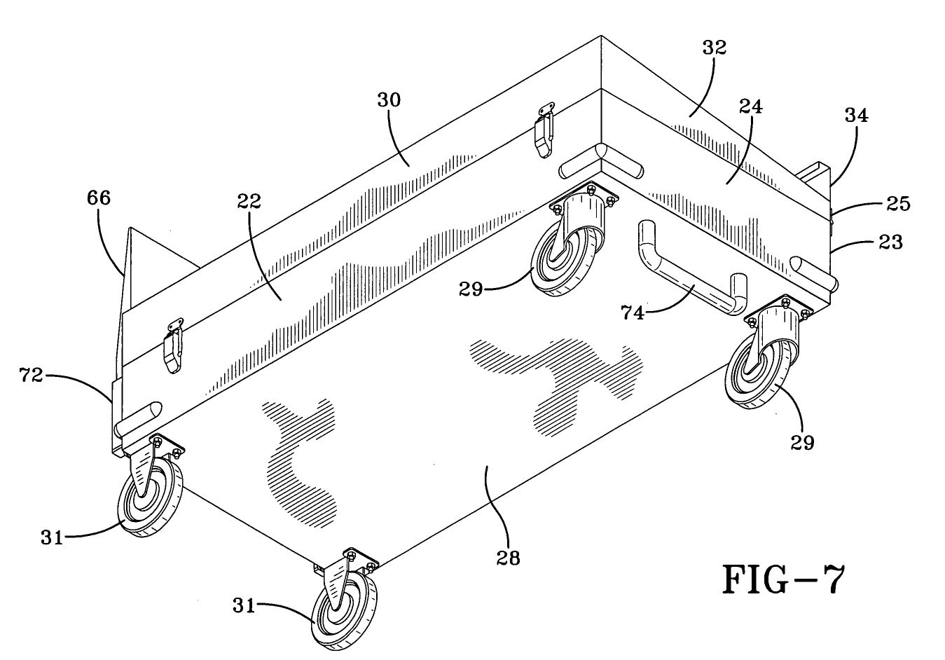

As best seen in FIGS. 6 and 7, tread plate 66 includes side flanges 70 which slideably cooperate with a pair of mounting flanges 72 provided on one of the end walls 24 carrying the fixed wheels 31. This configuration permits the present invention to be transformed into a hand truck for transporting boxed loads in cooperation with a gripping handle 74 described below, in a conventional manner to further enhance the versatility and convenience to the user.

U-shaped handle 74 may be fixedly disposed on bottom wall 28 near, but spaced from the joinder of the opposing end of bottom wall 28 relative to mounting flanges 72 to allow one to raise and manipulate the present invention in a hand truck configuration. It should be noted further that handle 74 also conveniently provides for facile handling of the present invention in this same disposition, without tread plate 66 affixed as shown, for transporting the main body 20 and any contents as a whole. For example, transporting main body 20 with its stored contents from a vehicle used to move from work site to work site or through an airport to the baggage check-in or from the baggage pick-up area in a manner associated commonly with other conventional forms of wheeled luggage represents a significant and practical convenience.

In view of the foregoing description, it should be readily understood by one of ordinary skill that the present invention provides multiple advantageous, easily transformable configurations for different functions highly useful to one who routinely is employed in room construction or remodeling type activities in a more convenient and efficient manner.

While certain preferred embodiments of the present invention have been disclosed in detail, it is to be understood that various modifications may be adopted without departing from the spirit of the invention or scope of the following claims.

1. An apparatus forming a dolly and portable tool box, comprising in combination;
a) a generally rectangular main body forming a primary tool storage compartment defined by a pair of opposing side walls, a pair of opposing end walls, a bottom wall, and a top wall;
b) said bottom wall including wheel means mounted for rolling movement of said main body over a supporting substrate with said top wall disposed in a generally parallel relationship to said supporting substrate;
c) said top wall movably mounted relative to at least one of said side walls between a closed position forming a lid enclosing said storage compartment and an open position permitting access to said compartment, said top wall in said closed portions defining a generally planar surface configured to receive and support a load for transport when disposed in a generally horizontal position relative to said supporting substrate.

2. The apparatus defined in claim 1 further including downwardly depending wall portions fixed to said top wall forming a secondary storage space between the interior surface of said top wall and the lower edges of said depending wall portions independent of said primary tool storage compartment.

3. The apparatus defined in claim 1 wherein the planar surface of said top wall in a closed position is inclined from an edge of one of said opposing side walls toward an edge of the other side wall and including a support frame removably mounted between an operative position extending vertically upward from said planar surface and a stored position releasably fixed to an interiorly facing surface of said top wall.

4. The apparatus defined in claim 2 wherein said planar surface of said top wall in said closed position is inclined from an edge of one of said side walls toward an edge of the opposing side wall and further including a support frame removably mounted to said top wall in a vertically extending first position operative to cooperate in supporting a load on said planar surface and a second storage position in a releasably fixed relationship to an interiorly facing surface of said top wall within said secondary storage space.

5. The apparatus defined in claim 4 wherein said wheel means includes a pair of castor wheels and a pair of fixed wheels, each mounted to said bottom wall near a corner of said main body formed at a joinder of said end walls and said side walls.

6. The apparatus defined in claim 5 further including a gripping handle mounted to said main body on or near to one said end walls and configured to allow one to lift one end of said main body upwardly for rolling transport of said main body solely upon one of said pair of wheels.

7. The apparatus defined in claim 1 including means to releasably latch said top wall in said closed position.

8. The apparatus defined in claim 2 wherein one of said downwardly depending wall portions fixed to said top wall includes a vertical lip extending above the joinder of said one depending wall portion to said top wall forming a rearward edge to a point approximately within a horizontal plane intersecting an opposing end of said top wall forming a forward edge.

9. The apparatus defined in claim 3 wherein said support frame includes a pair of spaced elongated legs vertically extending above said top wall and a cross member removably connected to an upper portion of said legs when said frame is disposed in said operative position.

10. The apparatus defined in claim 2 further including a gripping handle disposed near one end of said main body and configured to allow said one end of said main body to be tilted upwardly for rolling transport on a pair of wheels disposed near an opposing end of said main body.
